(19) United States
(12) Patent Application Publication
(10) Pub. No.: US 2008/0046705 A1
(43) Pub. Date: Feb. 21, 2008

(54) System and Method for Flexible SMP Configuration

(75) Inventors: Tomonori Hirai, Fremont, CA (US); Jyh Ming Jong, Fremont, CA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: TYAN COMPUTER CORPORATION, Taipei (TW)

(21) Appl. No.: 11/539,590

(22) Filed: Oct. 6, 2006

Related U.S. Application Data
(60) Provisional application No. 60/822,397, filed on Aug. 15, 2006.

(51) Int. Cl. G06F 15/177

(52) U.S. Cl. 713/1

(57) ABSTRACT

A system and method are provided to enable flexible symmetric multi-processor (SMP) configuration. The system includes plural bootable domains and a glue logic. The bootable domains include plural processors, one or more boot image and one or more bridge interface. Each of the bootable domains links to another through the connection between the processors. The glue logic receives and processes a configuration signal and generates enable/disable signals to enable/disable each of the bootable domains and define one or more actual boot domain. The processor of the enabled bootable domain initializes the dedicated actual boot domain by accessing boot instructions from the boot image through the bridge interface.

### BACKGROUND OF THE INVENTION

1. Field of Invention

The present invention relates to symmetric multi-processor configuration, and more particularly to a system and method for implementing flexible symmetric multi-processor configuration.

2. Related Art

Generally, SMP (symmetric multi-processor) configuration is usually fixed in a computer system equipped with multiple processors. In a typical implementation, the SMP configuration is basically defined and limited by hardware architecture. Generally, a bootable image (BIOS) is linked to a specific one of multiple processors (or CPUs) through a system chipset. The processor that links to the bootable image becomes a primary processor to initialize the rest of CPUs in the system.

FIG. 1 illustrates an 8-way computer system equipped with 8 CPU-chips/processors CPU0, CPU1, CPU2, CPU3, CPU4, CPU5, CPU6, and CPU7. Only CPU0 is connected to a boot image through a system chipset. Accordingly, the processor CPU0 will operate as a primary processor to boot up itself first and then the other processors CPU1, CPU2, CPU3, CPU4, CPU5, CPU6, and CPU7. That is the only SMP configuration type in the 8-way system. Namely, any of the processors CPU1, CPU2, CPU3, CPU4, CPU5, CPU6, and CPU7 is not able to enable self-boot-up, nor initialize the others.

### SUMMARY OF THE INVENTION

Accordingly, the present invention provides a system and method to enable flexible symmetric multi-processor (SMP) configuration.

The system according to the present invention includes plural bootable domains and a glue logic. The bootable domains include plural processors, one or more boot image and one or more bridge interface. Each of the bootable domains links to another through the connection between the processors. The glue logic receives and processes a configuration signal and generates enable/disable signals to enable/disable each of the bootable domains and define one or more actual boot domain. The processor of the enabled bootable domain initializes the dedicated actual boot domain by accessing boot instructions from the boot image through the bridge interface.

The glue logic according to the present invention includes a decoder, a latch unit and a power state machine. The decoder decodes the configuration signal and outputs a decoded configuration signal. The latch unit sends the enable/disable signals to each of the bootable domains according to the decoded configuration signal. The power state machine enables/disables the latch unit.

The method according to the present invention includes the following major steps. First of all, provide a configuration signal for a specific SMP configuration. Next, generate enable/disable signals according to the configuration signal for enabling/disabling each of the bootable domains. Then, define one or more actual boot domain according to the enable/disable signals; the actual boot domain includes one or more of the bootable domains with at least one enabled. Afterwards, access boot instructions by a primary processor of the actual boot domain from the boot image through the bridge interface; the primary processor is defined as the first processor of the enabled bootable domain in the actual boot domain. Eventually, initialize the actual boot domain by the primary processor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows an 8-way computer system in the prior art.

FIG. 2 shows a system for flexible SMP configuration according to an embodiment of the present invention.

FIG. 2A shows a specific multi-processor architecture related to the system illustrated in FIG. 2.

FIG. 2B shows a block diagram of the glue logic illustrated in FIG. 2.

FIG. 3 shows a 4-by-2 SMP configuration of the system illustrated in FIG. 2.

FIG. 4 shows a 2-by-4 SMP configuration of the system illustrated in FIG. 2.

FIG. 5 shows another system for flexible SMP configuration according to another embodiment of the present invention.

FIG. 6 shows another system for flexible SMP configuration according to another embodiment of the present invention.

FIG. 7 shows the flow chart of a method for flexible SMP configuration according to the present invention.

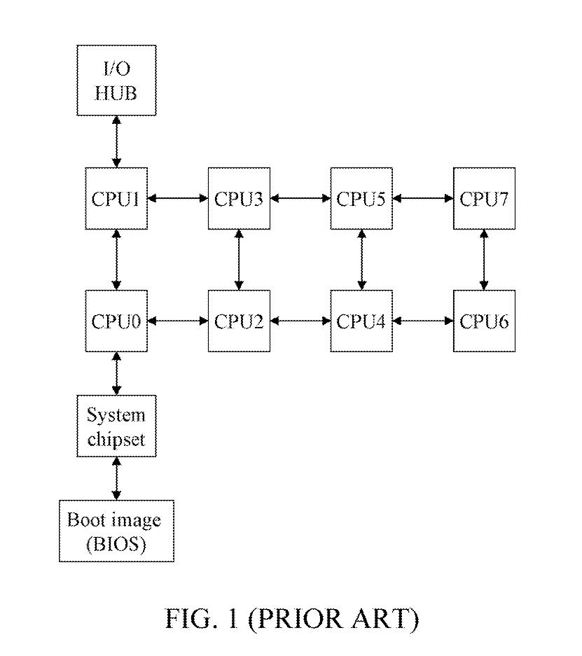

### DETAILED DESCRIPTION OF THE INVENTION

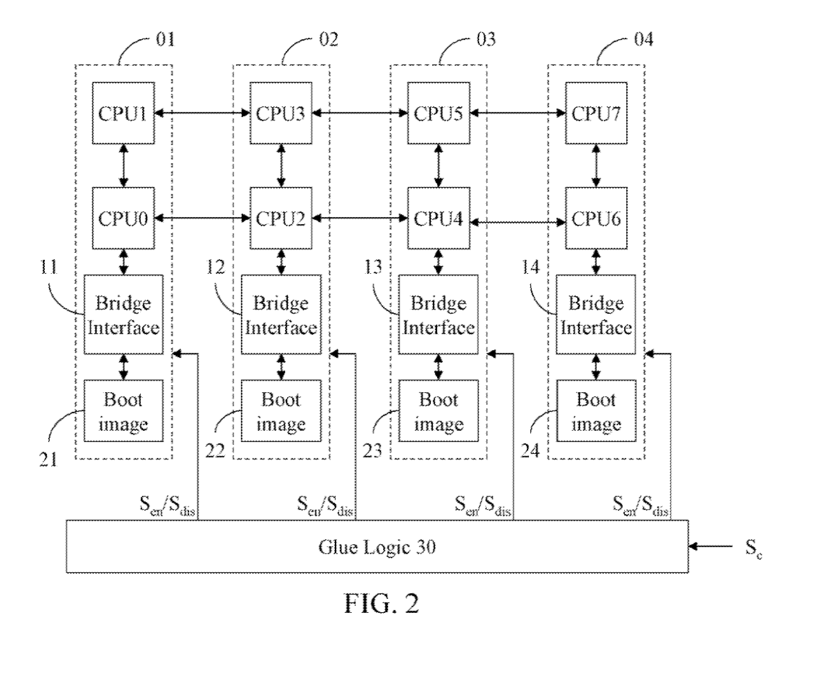

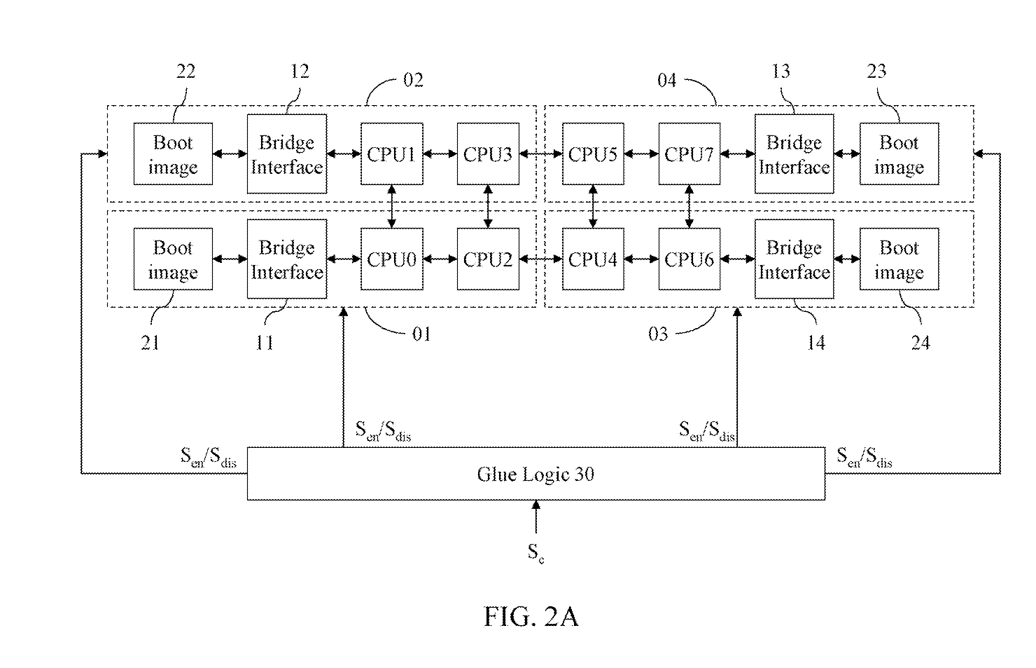

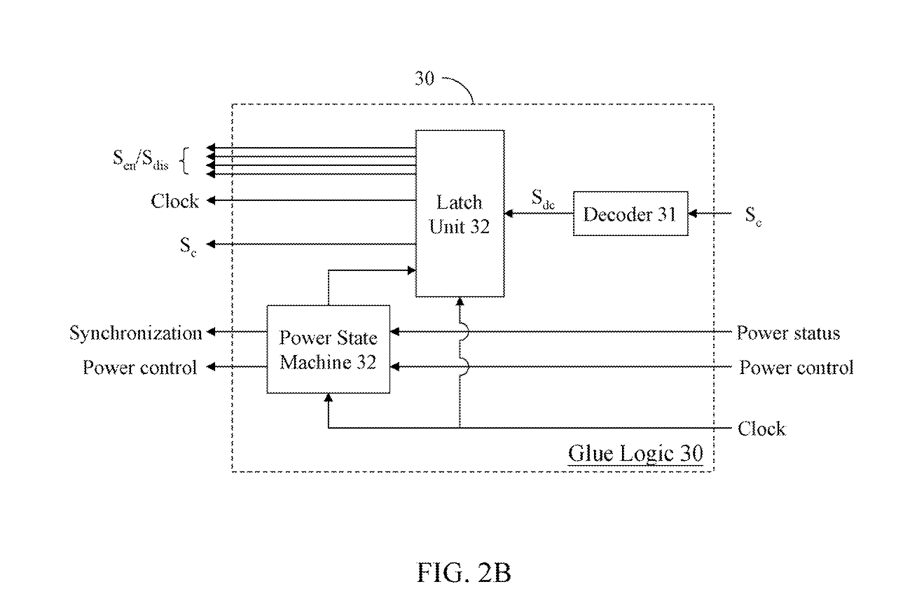

Please refer to FIG. 2. In an embodiment according to the present invention, a system for flexible SMP configuration mainly includes four first processors CPU0, CPU2, CPU4, CPU6, four second processors CPU1, CPU3, CPU5, CPU7, four bridge interfaces 11, 12, 13, 14, four boot images 21, 22, 23, 24, and a glue logic 30. In the embodiment all of the processors, the bridge interfaces and the boot images are divided into four sub systems called “bootable domains” 01˜04. The bootable domain 01/02/03/04 has one first processor CPU0/CPU2/CPU4/CPU6, one second processor CPU1/CPU3/CPU5/CPU7, one bridge interface 11/12/13/14 and one boot image 21/22/23/24. To implement flexible SMP configuration, at least two bootable domains exist in the system. Each of the bootable domains 01/02/03/04 links to another through the connection between the first processors CPU0, CPU2, CPU4, CPU6.

Each of the first and second processors CPU0˜CPU7, is a single chip processor configured in a dedicated processor socket and is equipped with single or more computing core. All the processors in the system and method according to the present invention support various SMP configurations, such as 1, 2, 4 or 8 processor chips and etc. Certainly, the number of processors in the bootable domain could be various; any numbers that the processors can support for various SMP configurations can be an option. Only there must be a first processor connecting with the boot image through the bridge interface to execute boot-up procedures.

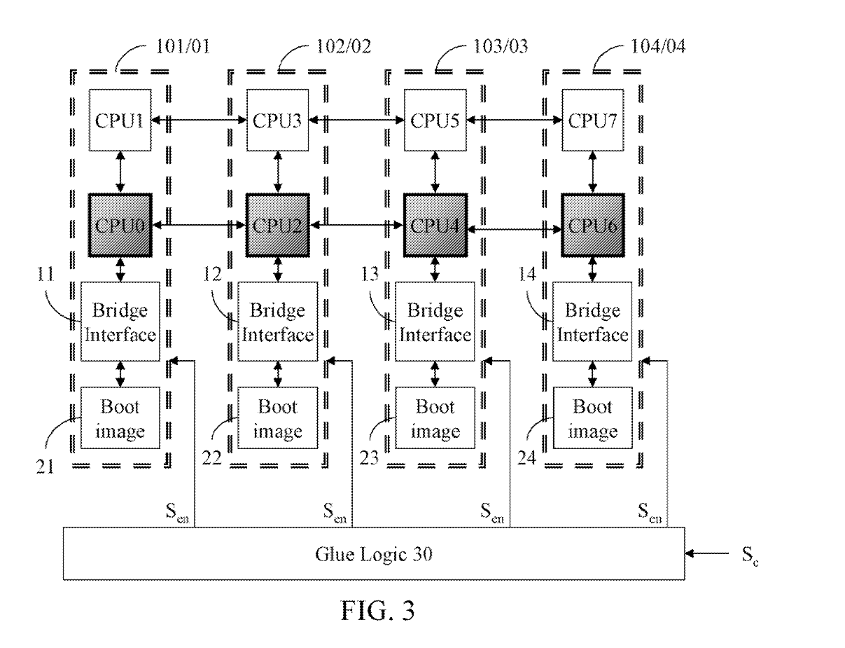

In FIG. 2 each of the processors supports up to four connection ports to connect with another processor(s) and/or the bridge interface 11/12/13/14. For those processors supporting up to three connection ports, FIG. 2A illustrates a practical multi-processor architecture. One of the examples that meet the requirements in FIG. 2A is the processor called “Opteron” provided by AMD (Advanced Micro Devices, Inc.). The processor connecting to the boot image through the bridge interface and initializing the other processor(s) in the enabled bootable domain of an actual boot domain (such as the actual boot domain 101 in FIG. 3) is defined hereinafter as “primary processor”. The actual boot domain includes one or more bootable domain, with at least one enabled. In the other hand, a processor initialized by other processor is called “slave processor” hereinafter. In FIG. 2, the first processors CPU0, CPU2, CPU4, CPU6 are possible to be primary or slave processors, depending on the scope of the actual domain. However, the second processors CPU1, CPU3, CPU5, CPU7 are all slave processors. All the first processors CPU0, CPU2, CPU4, CPU6 are connected respectively to the boot images 21, 22, 23, 24 via the bridge interfaces 11, 12, 13, 14, and also connect to each other between the bootable domains 01˜04; the second processor CPU1/CPU3/CPU5/CPU7 connects to the first processor CPU0/CPU2/CPU4/CPU6 in each bootable domain 01/02/03/04. Each of the processor topologies here and the following embodiments should be an explanatory example only, with no limitation to the present invention.

The boot image 21/22/23/24 is a bootable instruction image of executable program code implemented on a flash memory for system initialization, commonly called BIOS. The primary processor in the actual boot domain accesses instructions from the boot image through the bridge interface to execute specific initialization steps and boot up the bootable domain(s) in the actual boot domain.

The bridge interface 11/12/13/14 connects between the processors CPU0/CPU2/CPU4/CPU6 and the boot image 21/22/23/24 to form a bootable path for each bootable domain 01/02/03/04. The bridge interface defined in the invention is an interface between a processor and a memory with the boot image, which may be a single chip or multiple chips called “system chipset” with both North and South Bridges. Simply South Bridge still functions as well in some cases. The bootable path here is the combination of essential connection factors (such as buses, I/O pins, I/O functions) between the first processor and the boot image and/or boot procedures of BIOS that may be enabled/disabled by one or more enable/disable signal Sₑₙ/S_{dis} from the glue logic 30. Namely, the bootable path includes hardware implementation and/or software/firmware execution for system booting of each bootable domain. As to the initialization procedures and hardware connections between the processors, both may be utilized as parts of the bootable path. Accordingly, the bootable path includes the initialization procedures and hardware connections involved in the actual boot domain.

Please refer to both FIGS. 2 and 2B. The glue logic 30 receives and processes a configuration signal S_{c} and then generates four enable/disable signals Sₑₙ/S_{dis} to each of the bootable domains 01˜04. The glue logic 30 includes a decoder 31, a latch unit 32 and a power state machine 33. The decoder 31 receives and decodes the configuration signal S_{c} and then outputs a decoded configuration signal S_{dc} to the latch unit 32. The latch unit 32 outputs four dedicated enable/disable signals Sₑₙ/S_{dis} for each bootable domains 01˜04 according to the decoded configuration signal S_{dc}. The power state machine 33 receives control signals about clock, power status and power control to enable/disable the latch unit 32. Except the essential requirement, the enable/disable signals Sₑₙ/S_{dis}, other output signals including the configuration signal S_{c}, clock control, synchronization and power control are optional. If necessary, Clock control could utilizes control signals to change the clock distribution scheme. Power control and sync signals could use control signals to adjust power-up signals and synchronize power up sequence between bootable domains, if necessary.

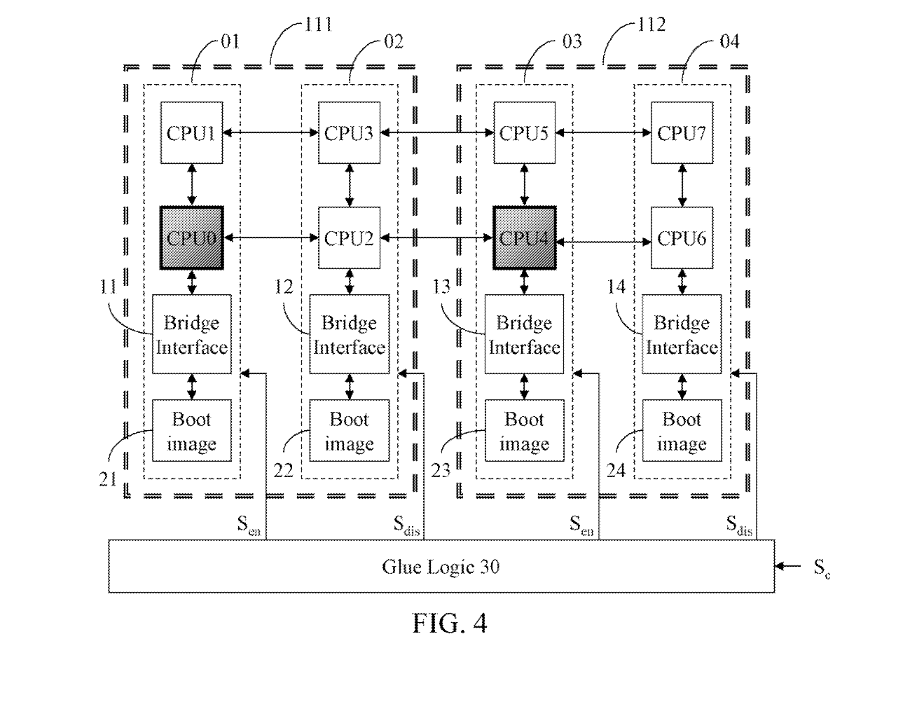

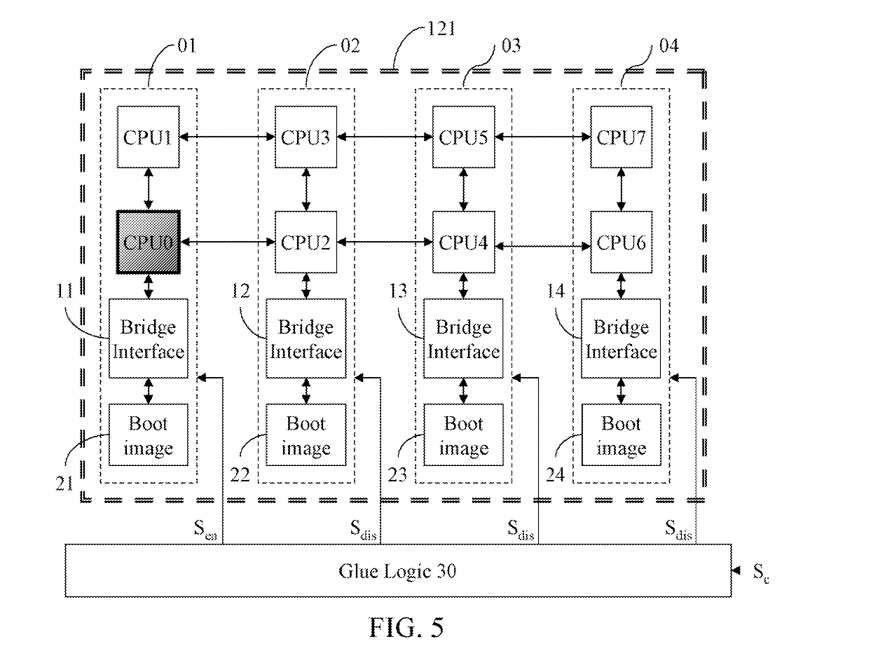

Basically, the glue logic 30 sets correct signal status of the enable/disable signals Sₑₙ/S_{dis} based on the configuration signal S_{c}, thereby enabling/disabling the bootable domains to control SMP configuration of the system. Detail control requirements are implementation dependent, such as control clock distribution, power up sequence and etc. The embodiment shown in FIG. 2 allows configuring the system as 4-by-2 processors (FIG. 3), 2-by-4 processors (FIG. 4) and 1-by-8 processors (FIG. 5).

In the present invention the ways to define the SMP configuration can be achieved through hardware means or system management firmware/software. The configuration signal S_{c} is generated according to the desired SMP configuration definition. A hardwired signals defined by DIP (dual in-line package)-switches or pull-up/down resistors, or configuration code defined by system management firmware/software, is capable of generating the configuration signal S_{c}. Furthermore, the SMP configuration needs to be predefined before the primary power turned on. That is, the system configuration definition has been selected through changing said hardware configuration during last power-off, or changing said system management firmware/software settings during last power-on, or simply changing the BIOS settings while terminating a boot-up procedure. After power on, the SMP configuration change(s) cannot be allowed or all changes are ignored.

4-by-2 Configuration

Please refer to FIG. 3. The 4-by-2 SMP configuration according to the system in FIG. 2 includes four actual boot domains 101, 102, 103, 104, each including only one bootable domain 01/02/03/04. According to the configuration signal Sc, the glue logic 30 generates four enable signals Sₑₙ to enable the bootable paths and all the bootable domains 01˜04. Each actual boot domain 101/102/103/104 has 2 processors (CPU0, CPU1)/(CPU2, CPU3)/(CPU4, CPU5)/(CPU6, CPU7). The first processor CPU0/CPU2/CPU4/CPU6 operates as the primary processor to access the boot instructions from the boot image 21/22/23/24 to initialize the slave processor (the second processor CPU1/CPU3/CPU5/CPU7) and the bootable domain 01/02/03/04 respectively. The actual initialization requirements depend on processor architecture. The BIOS needs to be acknowledged by the configuration signal Sc to stop the initialization some time according to the current SMP configuration. And also different power up sequence could be required for each bootable domain 01/02/03/04 respectively.

For example, a typical implementation in x86, the bootable image is stored in a flash memory attached to the South Bridge, which capable of enabling/disabling a bus which the BIOS flash memory is attached to. In this implementation, just to control the enable/disable signal Sₑₙ/S_{dis} to enable/disable the bootable paths and domains. In the other implementation that a South Bridge does not have said enable/disable feature, the glue logic 30 could need to control the signal(s) for reading boot codes on the BIOS flash memory. The system management firmware/software now is to operate four dual-processor sub-systems.

2-by-4 Configuration

Please refer to FIG. 4. This SMP configuration according to the system in FIG. 2 includes total 2 actual boot domains 111, 112, each having two bootable domains (01, 02)/(03, 04). Each domain has 4 chips of CPUs, CPU0/CPU1/CPU2/CPU3 and CPU4/CPU5/CPU6/CPU7. Only 2 bootable paths (domains) are enabled by the glue logic 30. Namely, According to the configuration signal Sc, the glue logic 30 generates two enable signals Sₑₙ to enable the bootable domains 01, 03; and two disable signals S_{dis} are send to disable the bootable domains 02, 04. Each actual boot domain 111/112 has 4 processors (CPU0, CPU1, CPU2, CPU3)/(CPU4, CPU5, CPU6, CPU7). The first processor CPU0/CPU4 operates as the primary processor to access the boot instructions from the boot image 21/23 to initialize the slave processors (including the first processor CPU2/CPU4 and the second processors (CPU1, CPU3)/(CPU5,CPU7)) and the bootable domain (01, 02)/(03, 04) respectively.

In each of the actual boot domains 111, 112, certain boot up sequences and initialization requirements for the 2 quad-processor sub-systems should be predefined in BIOS. And the system management firmware/software needs to change for operating the two quad-processor sub-systems.

1-by-8 Configuration

Please refer to FIG. 5. This SMP configuration according to the system in FIG. 2 includes only one actual boot domain 121, which has 8 processors CPU0˜CPU7 of four bootable domains 01˜04. Only one bootable path is enabled by the glue logic 30. The first processor CPU0 operates as the primary processor to initialize the slave processors including the first processors CPU2, CPU4, CPU6 and the second processors CPU1, CPU3, CPU5, CPU7. All the four bootable domains now combined as an 8-processor system.

For all the different configurations disclosed above, the system management firmware/software could have a default 1-by-8 configuration without further changes for the SMP configuration settings. Except the power-up sequence and clock distribution changes, the glue logic could need to control other implementation-dependent requirements for a flexible SMP system.

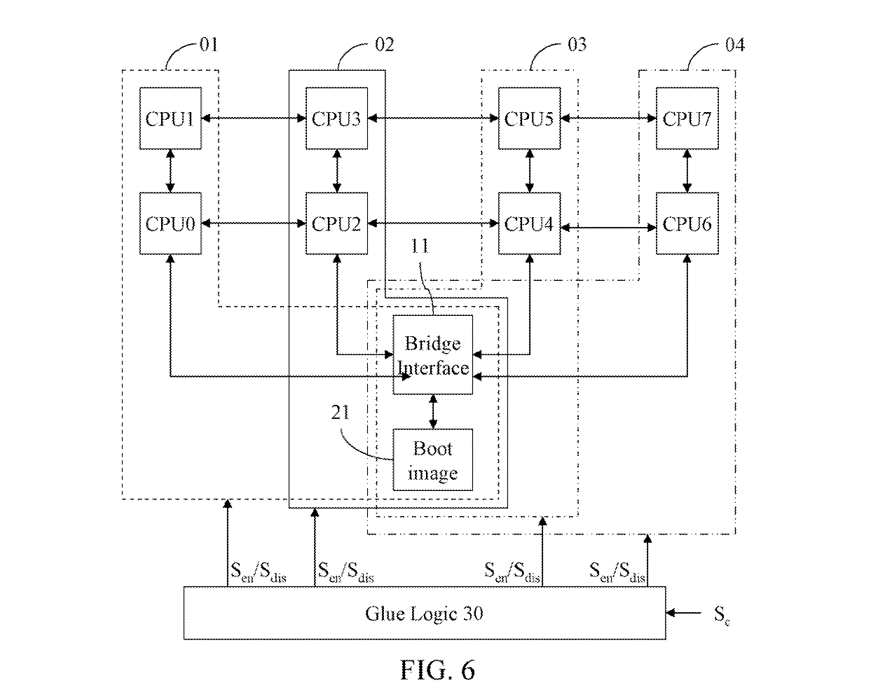

Please refer to FIG. 6. To obtain a simplified system, one or more specific bridge interface 15 and a boot image 25 supporting multiple accesses may be applied to a system with four bootable domains 01˜04. Then the bootable domains 01˜04 will no longer need dedicated sets of the bridge interface and the boot image. Only there will still be the dedicated enable/disable signals Sₑₙ/S_{dis} to enable/disable the bootable domains 01˜04 respectively for initialization.

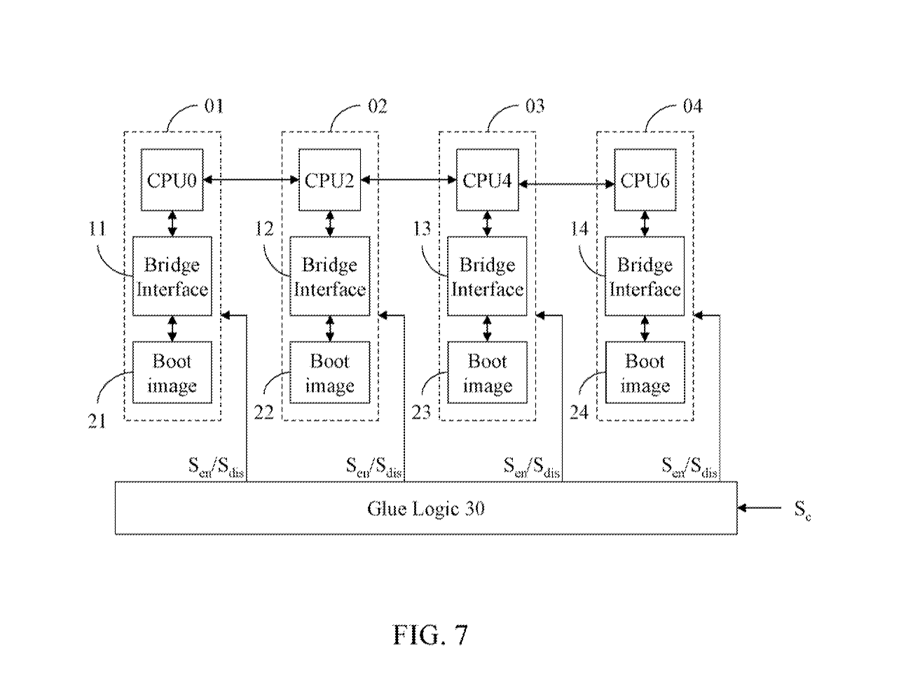

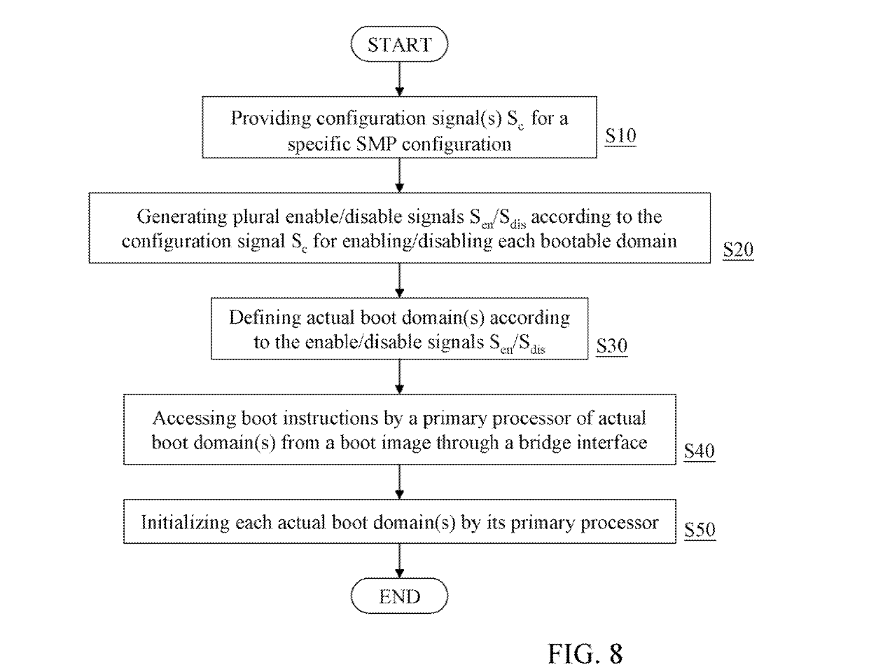

Please refer to FIG. 7. The second processors disclosed above are not essential matter or limitation for the implementation of the present invention. The bootable domain 01/02/03/04 in this SMP configuration includes only one processor, the first processor CPU0/CPU2/CPU4/CPU6. Most of the boot up procedures will be maintained, except those related to the second processors.

To initialize of the aforesaid flexible SMP system according to the present invention, a method is provided hereinafter to execute the specific boot-up steps for various SMP configuration.

Please refer to FIG. 8. The method for flexible SMP configuration according to the present invention is applied to the systems disclosed above. The major steps for the method include:

(1) Providing configuration signal(s) S_{c} for a specific SMP configuration (S10). The configuration signals S_{c} is generated by DIP(dual in-line package)-switches or pull-up/down resistors, or system management firmware/software.

The specific SMP configuration needs to be predetermined before the main power of the system is turned on.

(2) Generating plural enable/disable signals Sₑₙ/S_{dis} according to the configuration signal S_{c} for enabling/disabling each bootable domain (S20).

The glue logic receives and processes the configuration signal S_{c} to generate the enable/disable signals Sₑₙ/S_{dis} that enable/disable the bootable domains with the bootable paths enabled/disabled.

(3) Defining actual boot domain(s) according to the enable/disable signals Sₑₙ/S_{dis} (S30).

An actual boot domain includes at least one of the bootable domains. To define the actual boot domain, all the bootable domains need to be enabled or disabled first. Accordingly, step S30 may further include a step of enabling/disabling each bootable domain for initialization according to the enable/disable signals Sₑₙ/S_{dis}.

(4) Accessing boot instructions by a primary processor of each actual boot domain(s) from a boot image through a bridge interface (S40).

Along with the actual boot domain being defined, the primary processor is defined from the first processor(s) as well. The primary processor is the first processor of the enabled bootable domain in the actual boot domain, while the first processor is the processor in each bootable domain that connects to the boot image via the bridge interface. The primary processor will access the boot image linked through the bridge interface to execute initialization procedures for its actual boot domain.

(5) Initializing each actual boot domain(s) by its primary processor (S50).

The primary processor boots up the rest of processor(s) and components involved in the same actual boot domain. The rest of processors are slave processors, commonly including another first processor of the disabled bootable domain in the same actual boot domain, and/or the second processor (if any) that connects to the first processor. Therefore step 50 further includes a step of initializing slave processors in each actual boot domain.

Some other control features could be required to achieve “SMP operation” based on the architecture of processors and bridge interfaces (chipsets), such as clock distribution, power-up sequence and etc. Some specific implementations could possibly have a dedicated clock generation for an independent clock distribution system. Also, some bridge interfaces have a feature to control power-up sequence for each bootable domain and some system requires a special power-up sequence. Then, synchronization between bootable domains would be necessary.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for flexible symmetric multi-processor (SMP) configuration, comprising:
a plurality of bootable domains, including a plurality of first processor, at least one boot image, and at least one bridge interface connecting between the first processor and the boot image, each of the bootable domains linking to another through the connection between the first processors; and
a glue logic receiving and processing at least one configuration signal and generating at least one enable/disable signal to enable/disable each of the bootable domains to define at least one actual boot domain;
wherein the first processor of the enabled bootable domain initializes the dedicated actual boot domain by accessing boot instructions from the boot image through the bridge interface.

2. The system of claim 1, wherein the glue logic comprises:
a decoder decoding the configuration signal and outputting a decoded configuration signal;
a latch unit sending the enable/disable signals to each of the bootable domains according to the decoded configuration signal; and
a power state machine enabling/disabling the latch unit according to at least one control signal.

3. The system of claim 2, wherein the latch unit further outputs another of the configuration signal and a clock control signal.

4. The system of claim 2, wherein the power state machine receives a power status signal, a power control signal and a clock control signal, and outputs a synchronization signal and a power control signal.

5. The system of claim 1, wherein the enable/disable signal enables/disables a bootable path of each of the bootable domains to enable/disable the bootable domains, the bootable path comprising initialization procedures and hardware connections involved in the actual boot domain.

6. The system of claim 1, wherein the configuration signal is provided by DIP (dual in-line package) switches, pull-up/down resistors, or a system management firmware/software.

7. The system of claim 1, wherein each of the bootable domains further comprises at least one second processor connecting to the first processor, the second processor connecting with another between the bootable domains.

8. A method for flexible SMP configuration applied to a system with a plurality of bootable domains, the bootable domains including a plurality of first processor, a boot image and a bridge interface, the method comprising the steps of:
providing at least one configuration signal for a specific SMP configuration;
generating a plurality of enable/disable signals according to the configuration signal for enabling/disabling each of the bootable domains;
defining at least one actual boot domain according to the enable/disable signals, the actual boot domain including one or more of the bootable domains with at least one enabled;
accessing boot instructions by a primary processor of the actual boot domain from the boot image through the bridge interface, the primary processor being defined as the first processor of the enabled bootable domain in the actual boot domain; and
initializing the actual boot domain by the primary processor.

9. The method of claim 8, wherein the configuration signal is provided by DIP (dual in-line package) switches, pull-up/down resistors, or a system management firmware/software.

10. The method of claim 8 further comprising a step of initializing at least one slave processor in the actual boot domain, the slave processor comprising the first processor of the disabled bootable domain in the same actual boot domain.

11. The method of claim 10, wherein the slave processor further comprising a least one second processor that connects to the first processor in the same bootable domain.

12. The method of claim 8, wherein the defining step for the actual boot domain further comprising a step of enabling/disabling each of bootable domains for initialization according to the enable/disable signals.

13. The method of claim 12, wherein the enable/disable signal enables/disables a bootable path of each of the bootable domains to enable/disable the bootable domains, the bootable path comprising initialization procedures and hardware connections involved in the actual boot domain.

14. A system for flexible symmetric multi-processor (SMP) configuration, comprising:
a plurality of bootable domains, each including a first processor, a boot image, and a bridge interface connecting between the first processor and the boot image, each of the bootable domains linking to another through the connection between the first processors; and
a glue logic receiving and processing at least one configuration signal and generating at least one enable/disable signal to enable/disable each of the bootable domains to define at least one actual boot domain;
wherein the first processor of the enabled bootable domain initializes the dedicated actual boot domain by accessing boot instructions from the boot image through the bridge interface.

15. The system of claim 14, wherein the glue logic comprises:
a decoder decoding the configuration signal and outputting a decoded configuration signal;
a latch unit sending the enable/disable signals to each of the bootable domains according to the decoded configuration signal; and
a power state machine enabling/disabling the latch unit.

16. The system of claim 15, wherein the latch unit further outputs another of the configuration signal and a clock control signal.

17. The system of claim 15, wherein the power state machine receives a power status signal, a power control signal and a clock control signal, and outputs a synchronization signal and a power control signal.

18. The system of claim 14, wherein the enable/disable signal enables/disables a bootable path of each of the bootable domains to enable/disable the bootable domains, the bootable path comprising initialization procedures and hardware connections involved in the actual boot domain.

19. The system of claim 14, wherein the configuration signal is provided by DIP (dual in-line package) switches, pull-up/down resistors, or a system management firmware/software.

20. The system of claim 14, wherein each of the bootable domains further comprises at least one second processor connecting to the first processor, the second processor connecting with another between the bootable domains.
